(19) United States
(12) Patent Application Publication
(10) Pub. No.: US 2014/0249881 A1
(43) Pub. Date: Sep. 4, 2014

(54) COMPUTERIZED ESTIMATING TOOL FOR PROPOSED INSECT-CONTROL SPRAY CAMPAIGN

(71) Applicant: H.D. HUDSON MANUFACTURING COMPANY, Chicago, IL (US)

(72) Inventor: Manuel Lluberas, Jacksonville, FL (US)

(73) Assignee: H.D. HUDSON MANUFACTURING COMPANY, Chicago, IL (US)

(21) Appl. No.: 13/783,499

(22) Filed: Mar. 4, 2013

(51) Int. Cl. G06Q 10/06

(52) U.S. Cl. CPC G06Q 10/06313
USPC 705/7.23

(57) ABSTRACT

A computerized estimating tool that is used to create needs-assessment estimates, a multi-year budget, and an operational calendar for a proposed insect-control spray campaign presents a user with an electronic questionnaire that asks the user to input workforce data and has a field that, when clicked by the user, opens a worksheet in which the user provides demographic information on individual villages or communities to be covered by the proposed campaign, including the proportion of households in each community that or rural or urban. The tool has a program that retrieves the input data and other data stored in memory, calculates both a budget and an operational calendar for the proposed campaign, and generates a printable, narrative-form needs-assessment report.

### CROSS-REFERENCE TO RELATED APPLICATIONS

Not applicable.

### BACKGROUND OF THE INVENTION

The present invention relates generally to the field of insect-control, and more particularly to the planning and budgeting of indoor residual spray (IRS) campaigns against malaria mosquitoes and Triatomine bugs responsible for the transmission of Chagas disease.

In many countries, insect-control spray campaigns are often developed on a routine basis. At other times, they need to be developed on an emergency basis. Regardless of whether the campaign is developed on a routine basis or emergency basis, vector control program managers frequently spend days preparing needs assessments and estimates of the commodities required to implement sound vector control operations employing IRS.

BRIEF SUMMARY

The applicant has developed a computerized tool for quickly estimating the commodities required for a national, indoor residual spray campaign. The computerized tool presents the user with a brief questionnaire and then uses input information to quickly generate a needs assessment report, a multi-year budget and a plan of action tailored to the specified parameters. The user can then vary the input information to obtain alternative proposals, and select from among them.

Like computerized tools used in other fields, the new tool has a display, means for inputting data (including means for inputting data into boxes on a spreadsheet), a non-transitory computer-readable storage media and machine-readable instructions that are stored on the storage media and, when executed by a processor, cause the tool to present an electronic questionnaire on the display. The questionnaire has at least one field that, when clicked on by the user, opens a spreadsheet that has boxes in which a user is asked to provide information.

Unlike the questionnaires in any other known computerized tools, the questionnaire in the new tool asks the user to input demographic information about the population of the geographic area where a proposed insect-control spray campaign is being considered for use, including, for example, demographic information on individual villages or communities to be included in a proposed insect-control spray campaign. Separate demographic boxes may be provided for the name of each of those villages or communities and their populations. The number of households in each of those villages or communities can be calculated automatically from the user input based on the relative proportions of households in each of those villages or communities that are categorized as rural vs. urban.

The questionnaire also asks a user to input local workforce data concerning the proposed insect-control spray campaign. This workforce data may include estimated worker spray rates (the number of houses expected to be sprayed by a spray operator) for rural households and for urban households.

The questionnaire may also ask the user to input a desired end date for the proposed insect-control spray campaign and can provide a pull-down menu of possible insecticides for use in the proposed insect-control spray campaign.

The machine-readable instructions in the new tool retrieve the input data to calculate both a budget and an operational calendar for the proposed insect-control spray campaign and generate a printable, text-form needs-assessment report. In doing so, the machine-readable instructions may also use data input by the user into the spreadsheet boxes to calculate further data that is then displayed both in another field on the electronic questionnaire and in the needs-assessment report. For example, the instructions may retrieve input names of each of the villages or communities and display those names in the needs-assessment report.

In calculating the budget, the machine-readable instructions may retrieve the demographic information, the estimated worker spray rates and other workforce data.

In calculating the operational calendar, the machine-readable instructions may retrieve the desired end date, the demographic information and the workforce data to calculate a start date for the proposed insect-control spray campaign. That start date may be displayed in the operational calendar.

### BRIEF DESCRIPTION OF THE DRAWINGS

The invention may be better understood by referring to the accompanying drawings, in which:

FIG. 1 is view of a portable computer that can be programmed as the new computerized estimating tool.

FIG. 2 is a screenshot of an introductory page that may be displayed by the estimating tool.

FIG. 3 is a screenshot of a references page that may be displayed by the estimating tool.

FIG. 4 is a screenshot of an information page that may be displayed by the estimating tool.

FIGS. 5-7 are screenshots of a questionnaire that may be displayed by the estimating tool.

FIGS. 8-11 are screenshots showing pop-ups that may be displayed by the estimating tool.

FIG. 12 is a screenshot showing a population worksheet that may be displayed by the estimating tool.

FIGS. 13-15 are screenshots showing a needs-assessment report that may be generated and displayed by the estimating tool.

FIG. 16 is a screenshot showing other worksheets that may be displayed by the estimating tool.

FIG. 17 is a screenshot of a multi-year budget that may be generated and displayed by the estimating tool.

FIG. 18 is a screenshot of an operational calendar that may be generate and displayed by the estimating tool

### DETAILED DESCRIPTION

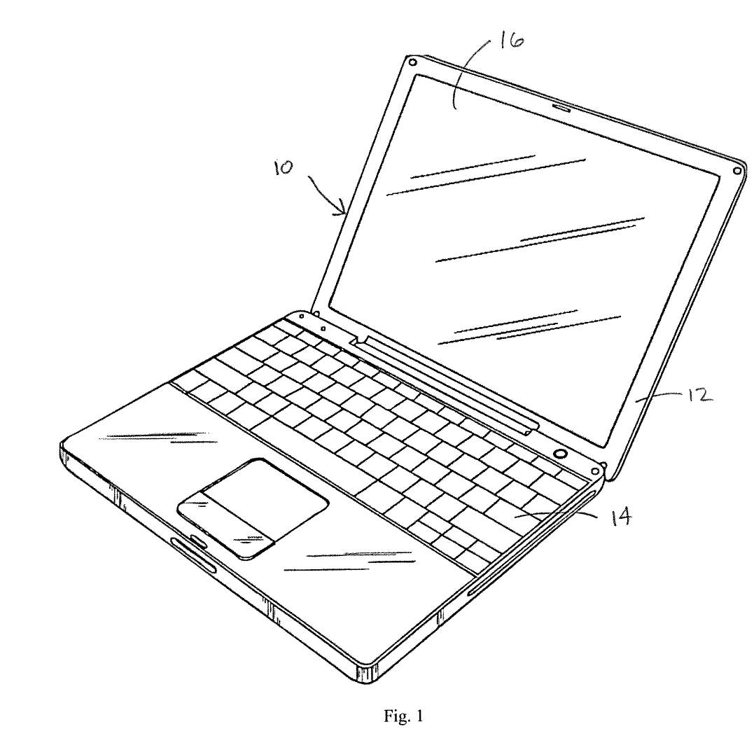

The new computerized estimating tool 10 can be made with a conventional portable computer 12 such as the one seen in FIG. 1. This computer 12 (i.e., a server, a laptop computer, an iPad or other tablet, a smart phone or any other computing device) has a keyboard 14 that provides a means for inputting data, non-transitory storage media within the computer and a display 16 on which information is made visible to the user.

In some embodiments of the invention, the tool could alternatively be configured for use with a computer mouse, a touch screen, or a microphone as the means for inputting data.

The non-transitory storage media could take the form of volatile or nonvolatile, removable or non-removable media implemented in any method or technology for storage of information, such as computer readable instructions, data structures, program modules or other data. Computer storage media includes, but is not limited to, random access memory (RAM), read only memory (ROM), EEPROM, FLASH memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can accessed by the computer 12. In the illustrated tool, the storage media carries a computer program.

The display 16 can be any conventional visual display, such as a LCD or LED screen. In some embodiments, it could also be an auditory display, such as a speaker.

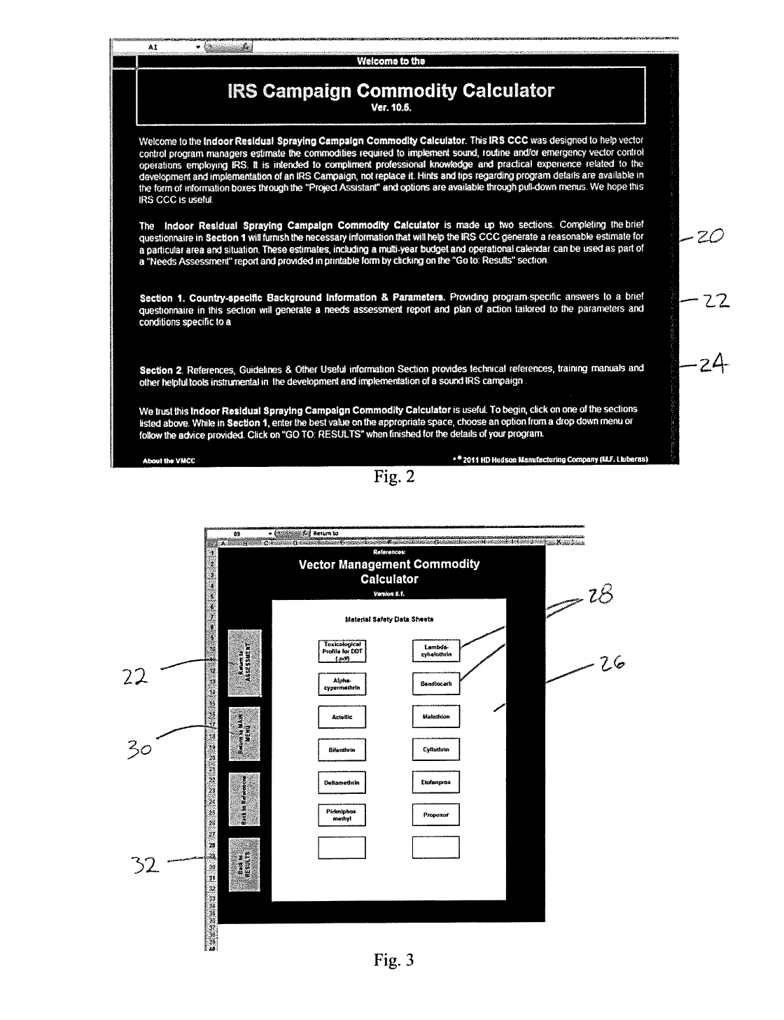

When activated by a user, the program in the illustrated tool retrieves and initially presents the user with an introductory page 20 on the display 16, such as the introductory page seen in FIG. 2. The illustrated introductory page provides the user with a general description of the manner in which the tool operates.

In this example, the introductory page 20 describes the intended purpose of the tool and explains that the tool provides a questionnaire (described in more detail below) in which the user is asked to furnish information that the tool will use to generate a needs estimate report for an indoor residual spray campaign. The introductory page also explains that the estimates will include a multi-year budget and an operational calendar, and that the report can be provided in printable form by clicking on a results link. Specifically, this introductory page 20 may begin, for example:
Welcome to the Indoor residual Spraying Campaign Commodity Calculator. This IRS CCC was designed to help vector control program managers estimate the commodities required to implement sound, routine and/or emergency vector control operations employing IRS. It is intended to compliment professional knowledge and practical experience related to the development and implementation of an IRS Campaign . . . Hints and tips regarding program details are available in the form of information boxes through the “Project Assistant” and options are available through pull-down menus. . . .
The Indoor Residual Spraying Campaign Commodity Calculator has a brief questionnaire that will furnish the necessary information to generate reasonable estimates for the particular area and situation. These estimates, including a multi-year budget and an operational calendar, can be provided in printable form by clicking on a “Go to results” link.

After the introductory language, the illustrated introductory page 20 explains that the user can begin by clicking on either a questionnaire link 22 or on a references link 24.

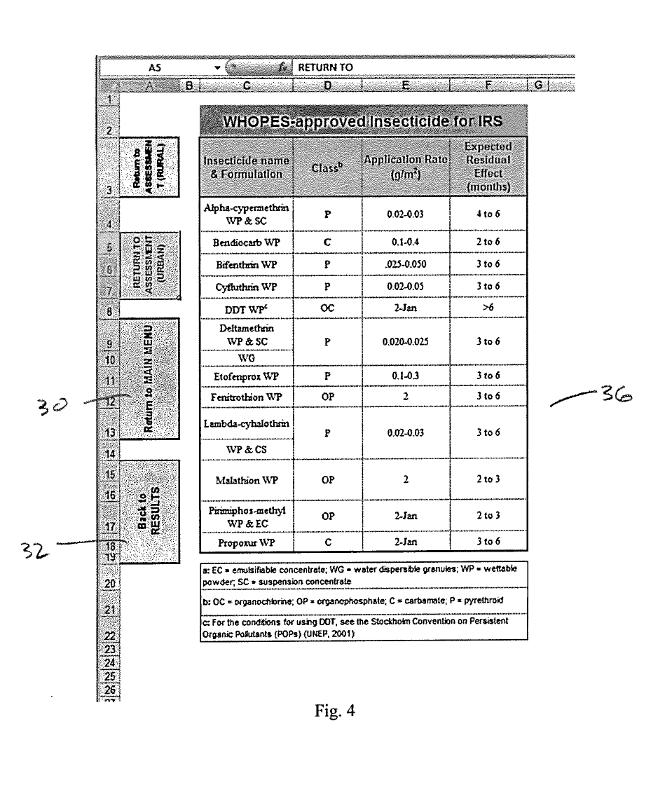

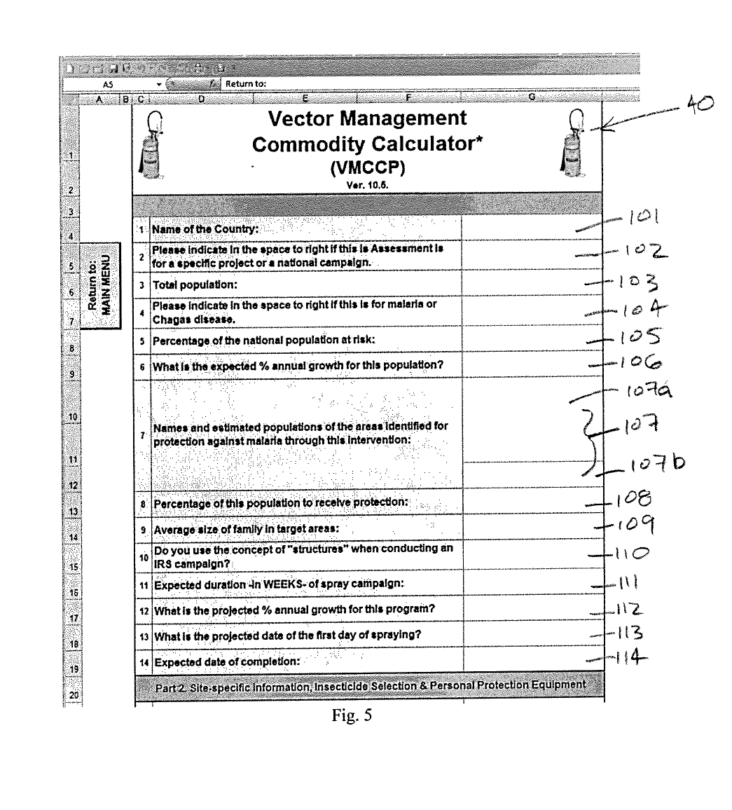

When a user clicks on the references link 24, the program retrieves and presents the user with a references page 26 such as the one seen in FIG. 3. This references page includes informational links 28, a home link 30, another questionnaire link 22, and a results link 32. When a user clicks on one of the informational links, the program retrieves and displays pertinent information, such as IRS-related training documents or information. For example, FIG. 4 illustrates an information page 36 that the program retrieves and displays when a user clicks on one of the informational links. When a user clicks on the home link, the program retrieves and displays the introductory page 20. When a user clicks on the results link, the program retrieves and displays the needs-assessment report that will be discussed in more detail below. When a user clicks on the questionnaire link, the program retrieves and displays a questionnaire.

### THE QUESTIONNAIRE

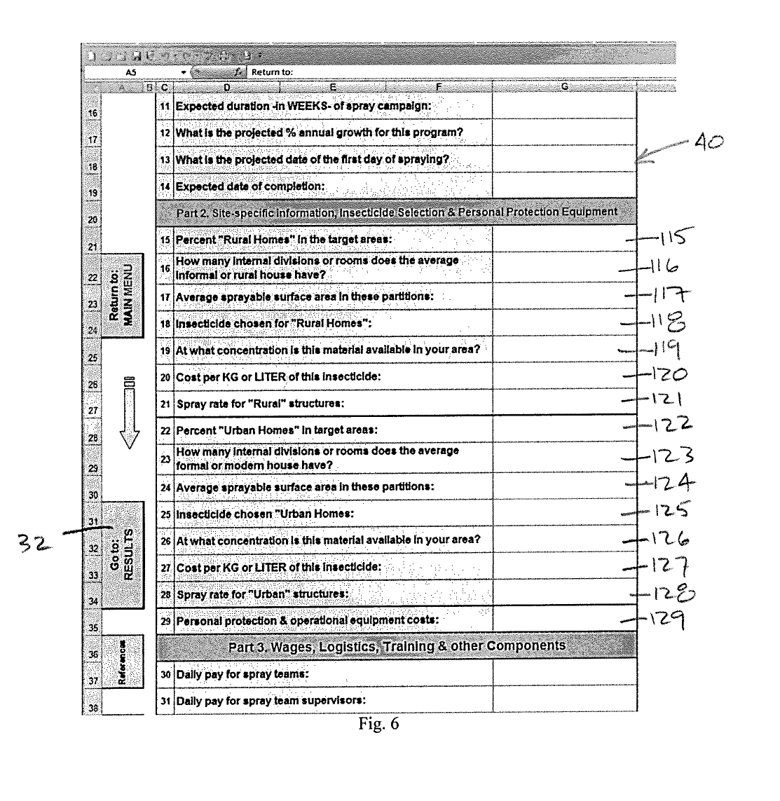

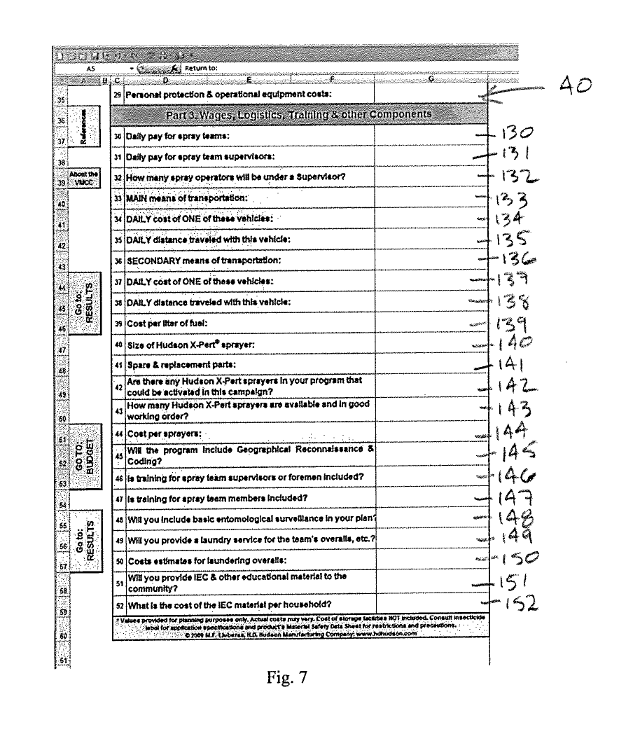

When a user clicks on the questionnaire link 22 on either the introductory page 20 or on the references page 26, the program in the illustrated tool 10 retrieves and displays a questionnaire 40 like the one seen in FIGS. 5-7. The illustrated questionnaire includes a home link 30, a references link 24, a results link 32 and a budget link 46, discussed below. The questionnaire also has separate fields in which the user can input data. The illustrated questionnaire groups the fields into three sections: an initial section seen in FIG. 5, a site-specific section seen in FIG. 6 and a workforce, materials and support data section seen in FIG. 7.

### FIELDS OF THE QUESTIONNAIRE

The initial section of the illustrated questionnaire 40, seen in FIG. 5, includes fields for general information and fields for demographic information.

In the illustrated questionnaire 40, the fields for general information include a field 101 for the name of the country in which the spray campaign is intended to be executed, a field 102 for name for the program, a field 104 for the type of illness that the program is intended to address (e.g., malaria or Chagas disease), a field 107 for the names and estimated populations of the individual villages or communities targeted for protection, a field 108 for the percentage of the at-risk population that the program hopes to protect, a field 111 for the expected duration of the campaign, a field 112 for the expected annual growth rate of the campaign 112, a field 113 for the desired first day of the campaign 113 and a field 114 for the desired completion day for the campaign.

The fields for demographic information include a field 103 for the total population of the country, a field 105 for the percentage of the national population at risk, a field 106 for the expected annual growth rate of the at-risk population and a field 109 for the average family size in the individual villages or communities targeted for protection.

The site-specific section of the illustrated questionnaire 40, best seen in FIG. 6, includes fields for further demographic information as well as fields for insecticide information.

The fields for further demographic information in this questionnaire 40 include fields 115, 122 for the percentages of rural and urban homes in the target areas, fields 116, 123 for the number of internal divisions or rooms in the average rural home and in the average urban home and fields 117, 124 for the average sprayable surface area in the average rural room and in the average urban room.

The fields for insecticide information in this questionnaire 40 include fields 118, 125 for the insecticide chosen for rural homes and for urban homes, fields 119, 126 for the concentrations of the insecticide available in the area, fields 120, 127 for the local cost of the insecticide and fields 121, 128 for the spray rates for rural homes and for urban homes.

The site-specific section also includes a field for the cost of personal protection and operational equipment 129.

The workforce data section of the illustrated questionnaire 40, best seen in FIG. 7, includes fields for logistical data. These fields include fields for worker data, fields for transportation data, fields for equipment data and fields for other training and educational data. The fields for worker data include fields 130, 131 for daily pay for operators and for supervisors and a field 132 for the number of operators working under a supervisor 132. The fields for transportation data include fields 133, 136 for the identity of the types of transportation to be used, fields 134, 137 for the daily cost for a type of vehicle, fields 135, 138 for the daily distance travelled by each type of vehicle and a field 139 for the local fuel price. The fields for equipment data include a field 140 for the identity of the type of sprayer to be used, a field 141 for whether the program will provide for spare parts, fields 142, 143 for identifying equipment that is already available and need not be purchased and a field 144 for the local cost of equipment that needs to be purchased. The fields for other training and educational data include a field 145 for whether geographical reconnaissance and geo-coding will be used, a field 148 for whether basic entomological surveillance will be used, fields 146, 147 for possible training of operators and supervisors, fields 149, 150 for possible laundering costs and fields 151, 152 for the possible cost of educational material to be distributed in the target areas.

USER COMPLETION OF THE DATA FIELDS

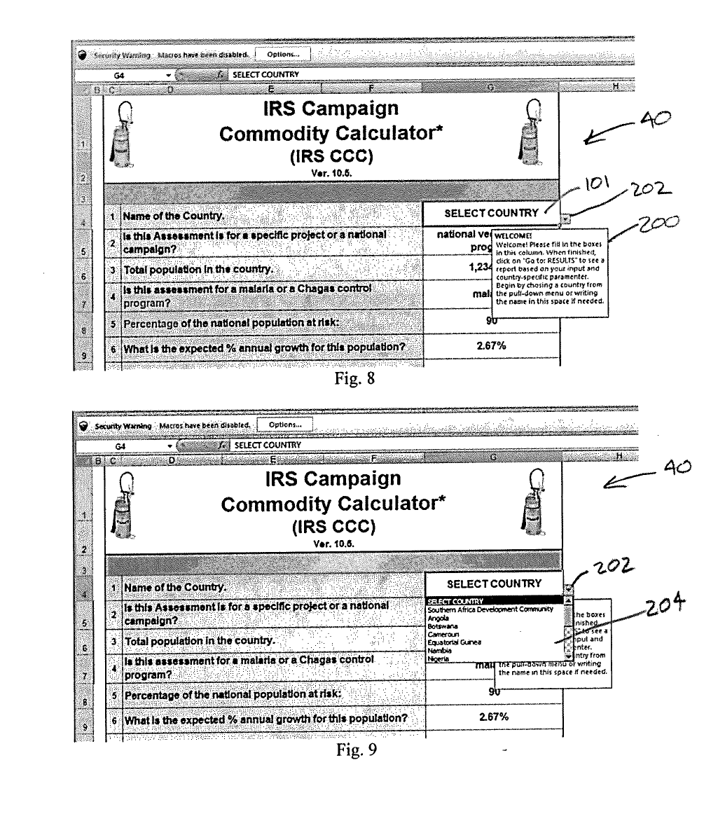

When a user clicks on one of the blank fields, the program retrieves and displays instructions relating to the completion of that field. For example, FIG. 8 shows a pop-up 200 that displays when a user clicks on the name-of-the-country field 101 for line 1 of the questionnaire 40. Various types of instructions can be provided.

In the example seen in FIG. 8, the pop-up 200 provides verbal instructions concerning completion of the field 101. Specifically, the pop-up instructs the user to use an associated pull-down menu to select the name of the country or select an entry that will enable the user to type in a name of a country. When the user clicks on a pull-down icon 202 in or adjacent to the field, the program retrieves and displays a pull-down menu 204, seen in FIG. 9. When a user clicks on the name of a country in the pull-down menu, the program retrieves that name and enters it in the field 101 for line 1 of the questionnaire 40. One of the options in the pull-down menu is “select country”, and when a user clicks on that menu item, the program returns the user to the field and enables the user to enter a country name in the field by typing using the keyboard 14.

Similarly, a pop-up for the next field 102 instructs the user to enter a name for the spraying program, and directs the user to an associated pull-down menu that provides name options as well as an option to enter a name by typing. The pop-up for the field 104 for line 4 of the questionnaire 40 similarly directs the user to use a pull-down menu.

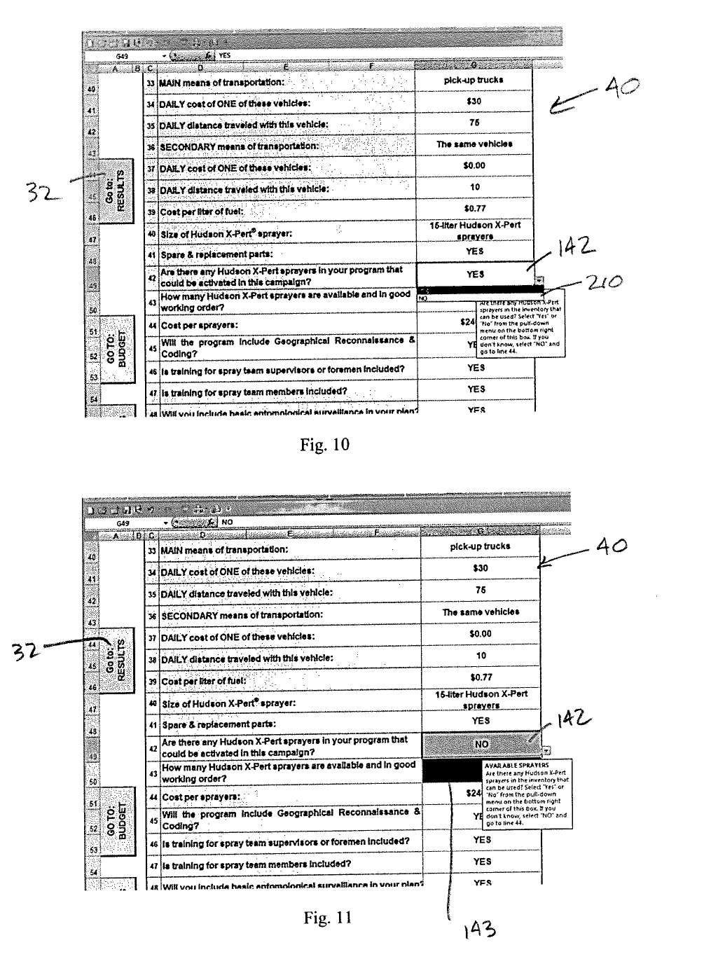

The field 142 for line 42 of the questionnaire 40 (directed to equipment that is already available and need not be purchased) directs user to a yes/no pull-down menu 210 seen in FIG. 10. When a user clicks on “no” in that menu, the program blacks out the corresponding field on the next line, as seen in FIG. 11, providing a clear visual indication that the user, having answered “no” in the field 142 for line 42, need not respond in the next field 143. Similar yes/no menus are associated with the fields 149, 150 associated with the forty-ninth and fiftieth lines of the questionnaire and with the fields 151, 152 associated with last two lines of the questionnaire.

The pop-ups for the fields 103, 105, 106 associated with lines 3, 5, and 6 of the questionnaire 40 provide the user with clarification of the information being sought in those fields. In connection with these fields, the program enables the user to enter information in the field by typing. In connection with the field 106 associated with line 6 (directed to population growth), the pop-up provides information that may assist the user in responding (in this case, a statement that most countries have a population growth of around 1.6%.)

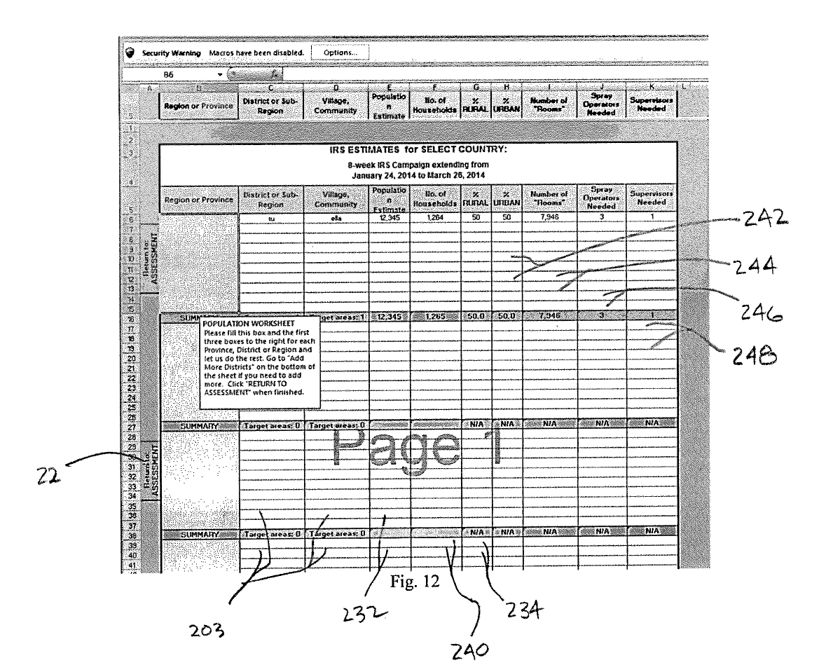

Line 7 of the illustrated questionnaire 40 is directed to identifying the populations of the target areas, and, as seen in FIG. 5, has two fields 107a, 107b, one above the other. The program calculates the number for the lower field 107b, and the pop-up for that field accordingly instructs the user not to write in that field. The pop-up for the upper field 107a instructs the user to click on the box to the left. When a user clicks on that box, the program retrieves and displays a population worksheet 220 like the one seen in FIG. 12.

### THE POPULATION WORKSHEET

The population worksheet 220 has separate columns in which regions, districts or subregions and individual villages or communities that are to be covered by the spraying program can be identified in demographic boxes. In the illustrated population worksheet, these demographic boxes include columns of boxes 230 for the name of each village or community to be covered, boxes 232 for the population of each village or community and boxes 234 for the percentage of rural houses in that village or community. This population worksheet also has columns of derived boxes that include boxes 240 for the number of households in each village or community, boxes 242 for the percentages of urban households, boxes 244 for the number of rooms, boxes 246 for the number of spray operators needed, and boxes 248 for the number of supervisors needed. The estimating tool 10 instructs the user (for example through presentation of one or more pop-ups) to complete the demographic boxes, and advises the user (in this case by advising the user to “let us do the rest” or to “STOP! Do not write in this space”) that the tool will calculate values for the derived boxes.

In this example, the program may calculate a value for the number of households in a community by retrieving both the population of that village or community that is provided in the demographic box 232 and the value that the user input in the field 109 for line 9 of the questionnaire 40 as the average size of a family in the target area and dividing the total population by the average family size. The program enters the calculated value in the derived box 240 for number of households and stores it in the memory in the storage media.

The program can calculate the percentage of urban households by retrieving the number of rural households that the user entered in the demographic box 234 and subtracting that value from 100. The program enters that value in the derived box 242 for the percentage of urban households and stores it in memory in the storage media.

The program can calculate the number of rooms by using the number of households that it calculated in the derived box 240, the percentage of rural households that the user entered in demographic box 234, the percentage of urban households that it calculated for the derived box 242 and the numbers of internal divisions that the user entered in the fields 116, 123 for the corresponding lines of the questionnaire 40.

The program can calculate the number of spray operators needed for a village or community by using the number of rooms that it calculated and stored in connection with derived box 246 and the spray rates that the user provided in the fields 121, 128 of the questionnaire 40. That number is stored and displayed in the derived box 246 for the number of spray operators for that village or community.

The program can calculate the number of supervisors needed for any individual village or community by using the number of spray operators that it calculated and stored in connection with the derived box 246 as being needed for that village or community and the number that the user entered in the field 132 of the questionnaire 40 concerning the number of spray operators to be supervised by each supervisor. That number is stored and displayed in the derived box 248 for the number of supervisors need for that village or community.

The illustrated population worksheet 220 also has a questionnaire link 22 that, when clicked by the user, causes the program to retrieve and display the questionnaire 40. When the questionnaire is again displayed, the program retrieves the information that was stored and entered in the demographic boxes and the derived boxes, calculates a total population to be addressed by the proposed spray campaign by summing the populations for the target areas and displays the pertinent information in the fields 107, 115, 122 for lines 7, 15, and 22 of the questionnaire concerning the names and populations of the area to be covered by the campaign and the percentages of urban and rural homes. The corresponding pop-up boxes for those fields accordingly instruct the user not to write in those fields.

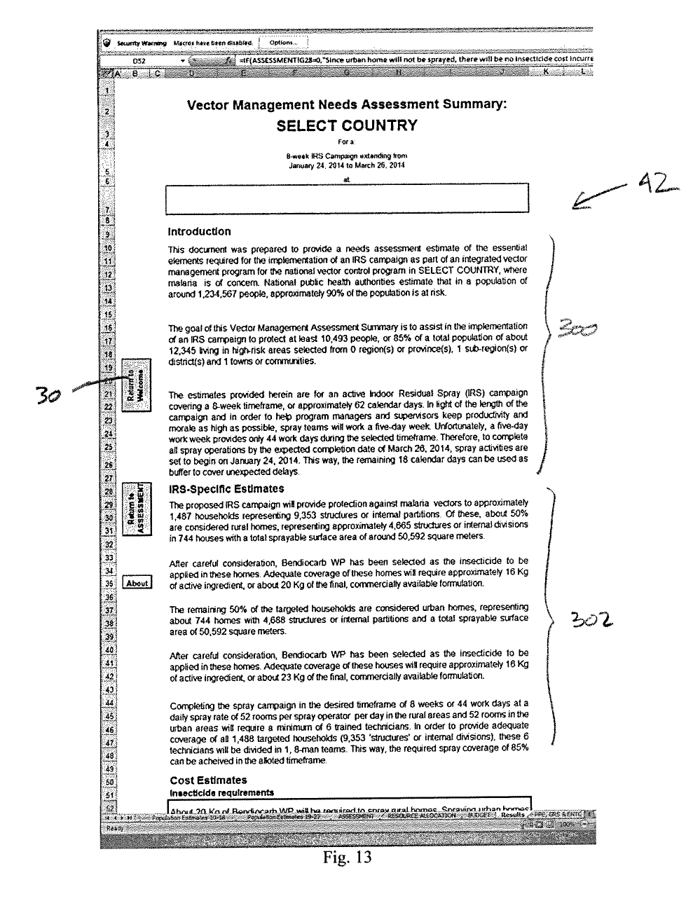

As noted above, the questionnaire 40 has a results link 32 seen in FIG. 6. When a user clicks on the results link, the program retrieves a report template from the storage media and generates and displays a needs-assessment report 42 like the one seen in FIGS. 13-16.

### THE NEEDS-ASSESSMENT REPORT

The illustrated needs-assessment report 42 is a printable document in which estimates for the proposed spray campaign are provided in narrative form. The illustrated needs-assessment report includes an introductory section 300, a program overview section 302 and a cost estimate section 304. When the program displays the needs-assessment report on-screen, it also displays a budget link 46, a schedule link 306, a questionnaire link 22, a references link 24 and a home link 30. These links are not included in the report when it is printed.

### THE INTRODUCTORY SECTION OF THE NEEDS-ASSESSMENT REPORT

The illustrated introductory section 300 includes the title that the user input into the field 102 for line 2 of the questionnaire 40 and summarizes, in narrative form, key aspects of the data that the user entered. In this example, it narrates the disease that is of concern, the size of the population estimated to be at risk (both in absolute terms and as a percentage of the overall population) and the size of the population targeted for protection (in absolute terms, as a percentage of the local population and in terms of number of communities to be targeted).

The introductory section 300 also provides a narrative description of the duration of the proposed campaign, which the program calculates using (among other things) the length of an expected workweek. The narrative identifies a calculated start date and a calculated completion date for the campaign, and enumerates a number of days to be scheduled in anticipation of unscheduled delays.

For example, the template for the introductory section 300 can read:
This document was prepared to provide a needs assessment estimate of the essential elements required to implement an IRS campaign as part of an integrated vector management program for the national vector control program in ______, where ______ is a concern. National public health authorities estimate that in a population of around ______ people, approximately ______ % of the population is at risk.
The goal of this assessment summary is to assist in the planning and implementation of an IRS campaign to protect at least ______ people, or ______ % of the total population of about ______ living in high-risk areas selected from region(s) ______ or provinces(s), ______ subregion(s) or districts(s) and ______ towns or communities.

The estimates provided here are for an active Indoor Residual Spray (IRS) campaign covering a ______-week timeframe, or approximately ______ calendar days. In light of the length of the campaign and to help program managers and supervisors keep productivity and morale high, spray teams will work a five-day week. Unfortunately, a five-day work week provides only ______ working days during the selected timeframe. Therefore, to complete all spray operations by the expected completion date of ______, spray activities are set to begin on ______. This way, the remaining ______ calendar days can be used as buffer to cover unexpected delays.

### THE PROGRAM OVERVIEW SECTION OF THE NEEDS-ASSESSMENT REPORT

The illustrated program overview section 302 explains, in narrative form, the extent of scope of the proposed program, providing a calculated value for the number of households and structures or internal partitions to be protected. It also summarizes some of the assumptions used, including, for example, composite percentages of rural and urban homes (calculated by the program using the values entered and stored in the boxes 234, 240, 234, 242 of the population worksheet 220 for populations and percentages), a number of rural and urban structures to be protected (calculated by the program using the values entered and stored in the boxes 116, 123 for lines 16 and 23 of the questionnaire 40), and the aggregate total sprayable surface areas to be targeted in each of those types of homes (calculated by the program using the values entered by the user in the boxes 117, 124 for lines 17 and 24 of the questionnaire). The program overview also narrates the insecticide selected for use (retrieving the data from the user's entries in the boxes 118, 125 for lines 18 and 25 of the questionnaire) and estimates the volume of insecticide needed both for rural use and for urban use (calculated by the program using the data entered and stored in boxes 119, 126 for lines 19 and 26 of the questionnaire) narrating that volume both in volume of active ingredient and in volume of the commercially available formulations.

Finally, the program overview section 302 recaps the duration of the spray campaign and identifies the number of spray operators required to complete the campaign in the desired time frame. The program calculates this on a community-by-community basis, retrieving the data entered by the user in the fields 121, 128 for in lines 21 and 28 of the questionnaire 40 for the average number of urban and rural rooms to be sprayed each day per operator and presuming a workweek that provides one or more days off per week. The total number of rooms (from the data entered in the fields 116, 123 for lines 16 and 23 of the questionnaire) is divided by the average number of rooms to be sprayed per day and by the number of days in the proposed schedule (from the data entered in the fields 113, 114 for lines 13 and 14). The size of the teams is narrated using the data entered by the user in the field 132 for line 32, and the number of teams for each community is calculated by dividing the number of sprayers needed by the size of the teams. The total number of teams is calculated by summing the number of teams required for each community. The percentage of the total coverage that is expected to be achieved in the proposed timeframe is calculated by summing the expected performance in each community and dividing by the sum of the total surfaces calculated for each community, and is narrated as the expected result of the campaign.

In this example, the template for the program overview section can read:
The proposed IRS campaign will provide protection against ______ vectors to approximately ______ households representing ______ structures or internal partitions. Of these, about ______ % are considered rural homes, representing approximately ______ structures or internal divisions in ______ houses with a total sprayable surface area of about ______ square meters.
After careful consideration, ______ has been selected as the insecticide to be applied in these homes. Adequate coverage of these homes will require approximately ______ Kg of active ingredient, or about ______ Kg of the final, commercially available formulation.

The remaining ______ % of the targeted households are considered urban homes, representing about ______ homes with ______ structures or internal partitions and a total sprayable surface area of about ______ square meters.
After careful consideration, ______ has been selected as the insecticide to be applied in these homes. Adequate coverage of these homes will require approximately ______ Kg of active ingredient, or about ______ Kg of the final, commercially available formulation.
Completing the spray campaign in the desired timeframe of ______ weeks or ______ working days at a daily spray rate of rooms per spray operator per day in the rural areas and ______ rooms in the urban areas will require a minimum of ______ trained technicians. To provide adequate coverage of all ______ targeted households (______ “structures” or internal divisions), these ______ technicians will be divided into ______ ______-man teams. That way, the required spray coverage of ______ % can be achieved in the allotted timeframe.

### THE COST ESTIMATE SECTION OF THE NEEDS-ASSESSMENT REPORT

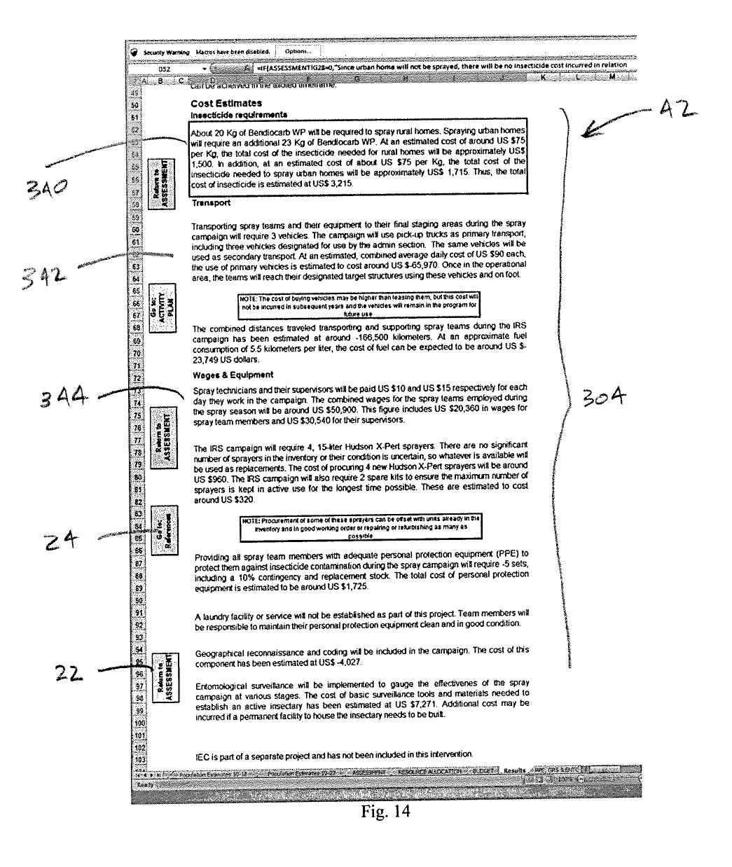

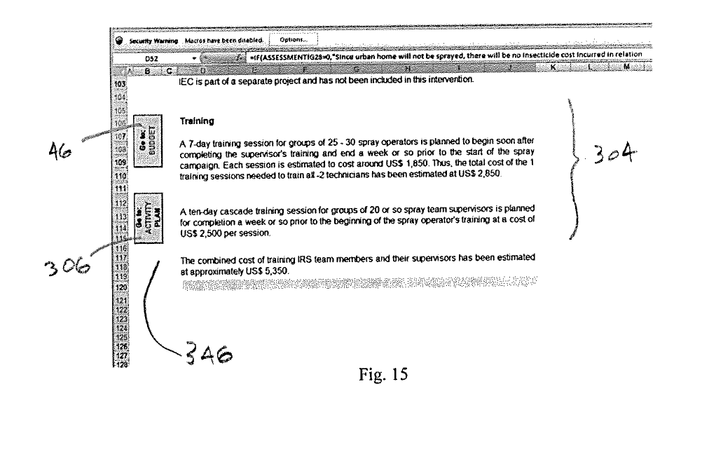

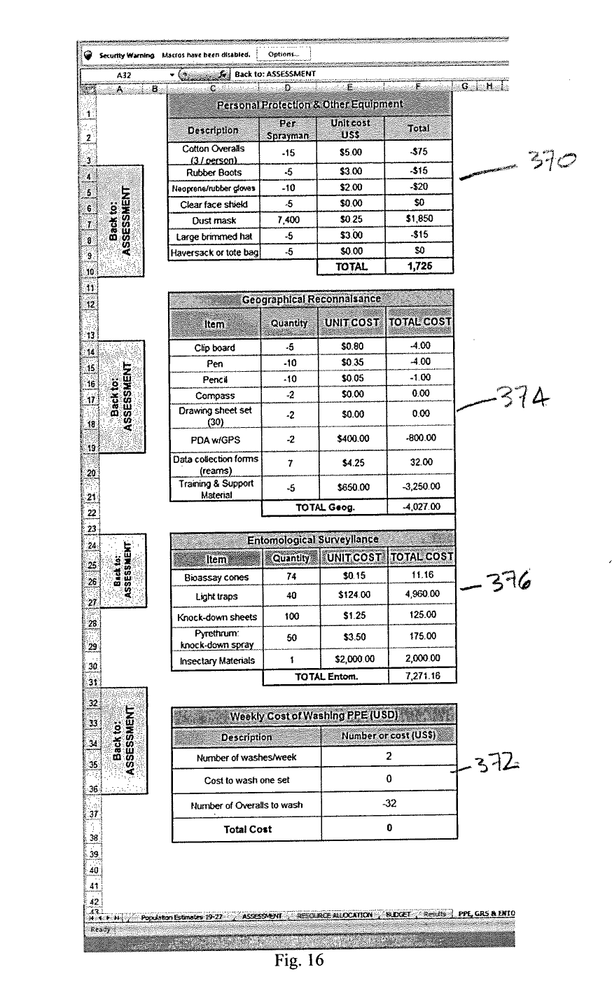

The illustrated cost estimate section 304 seen in FIGS. 14 and 15 explains, again in narrative form, the expected costs of the proposed spray campaign. The illustrated cost estimate section is divided into an insecticide requirement subsection 340, a transport requirement subsection 342, a wages and equipment requirements subsection 344 and a training requirements subsection 346.

The insecticide requirements subsection 340 narrates both the volume of insecticide needed for rural homes and the volume of insecticide needed for urban homes. These volumes are calculated by retrieving the number of homes (calculated, using the data entered in the fields 107, 108, 109 for lines 7, 8, and 9 of the questionnaire 40 concerning the size of the population and the average family size), the rural/urban percentages (from the fields 115, 122 for lines 15 and 22) and the sprayable surface areas in the average home of each type (calculated using the data from the fields 116, 117, 123, 124 for lines 16, 17, 23, and 24). The cost of the insecticide is calculated using these volume estimates and the local insecticide cost entered in the fields 120, 127 for lines 20 and 27. This calculated cost of the insecticide is narrated.

In this example, a template for the insecticide requirements subsection 340 can read:
About ______ Kg of ______ will be required to spray rural homes. Spraying urban homes will require an additional ______ Kg of ______. At an estimated cost of about US $______ per Kg, the total cost of insecticide needed for rural homes will be approximately US $______. In addition, at an estimated cost of around US $______ per Kg, the total cost of insecticide needed for urban homes will be approximately US $______. Thus, the total cost of insecticide is estimated at US $______.

The transport requirements subsection 342 provides a narrative summary of the transportation requirements for the proposed spray campaign. To calculate the number of vehicles that will be required for the campaign, the program retrieves the number of teams that is calculated as being needed for the campaign and adds a number for vehicles for administrative use. The program calculates the program cost of these vehicles by retrieving the daily cost of the vehicle entered in the field 134 for line 34 of the questionnaire 40 and multiplying it by the calculated length of the campaign to provide a base transportation cost 360, which is narrated. The program also calculates the total distance travelled in the vehicles by retrieving the daily average daily distance travelled entered in field 135 for line 35 by the number of vehicles calculated as being needed and the length of the campaign, and narrates the total distance travelled in the transport requirements subsection. The program also retrieves an average fuel consumption figure (for example, in terms of kilometers per liter of fuel) that is stored in the storage media for each of the possible types of vehicles, and multiplies that average fuel consumption by the calculated cumulative distance travelled and the local fuel cost retrieved from the field 139 for line 39 of the questionnaire 40 to provide an estimated fuel cost. The retrieved fuel average consumption figure and the estimated fuel cost are both narrated in the needs-assessment report 42.

In this example, a template for the transport requirements subsection can read:
Transporting spray teams and their equipment to their staging areas during the spray campaign will require ______ vehicles. The campaign will use ______ as the primary transport, including ______ vehicles designated for use by the administration section. The same vehicles will be used as secondary transport. At an estimated, combined daily cost of US $______ each, the use of primary vehicles is estimated to cost around US $______. Once in the operational area, the teams will reach their designated target structures using these vehicles and on foot.
The combined distance traveled transporting and supporting spray teams during the IRS campaign has been estimated at about ______ kilometers. At an approximate fuel consumption of ______ kilometers per liter, the cost of fuel is estimated at about US $______.

The wages and equipment subsection 344 narrates the local labor rates entered in the fields 130, 131 for lines 30 and 31 of the questionnaire 40 and includes a narrative summary of a calculated labor cost. The calculated labor cost is calculated by retrieving the data entered in the fields 130, 131 for lines 30 and 31 concerning local labor rates and multiplying those rates by the number of operators and supervisors needed and by the anticipated duration of the campaign.

When a user has indicated that there are no sprayers in inventory, a template for the wages and equipment subsection 334 can read:
Spray technicians and their supervisors will be paid US $______ and US $______ respectively for each day they work in the campaign. The combined wages for the spray teams employed during the spray season will be about $______ . This figure includes US $______ in wages for spray team members and US $______ for their supervisors.
The ______ campaign will require ______ ______ sprayers. There are no significant numbers of sprayers in inventory or their condition is uncertain, so whatever is available will be used as replacements. The cost of procuring ______ new ______ sprayers will be about US $______.
The ______ campaign will also require ______ spare kits to ensure the maximum number of sprayers is kept in active use for the longest time possible. These are estimated to cost about US $______.

The wages and equipment subsection 344 also includes a narrative summary of available spraying equipment (if any) and a calculated equipment cost. The calculated equipment cost can be calculated by retrieving the calculated number of sprayers required for the campaign and subtracting any existing inventory (from the data entered in the field 143 for line 43 of the questionnaire 40) to determine a number of sprayers to be purchased. That number is multiplied by the average local sprayer cost entered in the field 144 for line 44. In this example, the calculated number of sprayers to be purchased includes a suggested number of spare kits.

The wages and equipment subsection 344 also includes narrative cost estimates for personal protection equipment, for laundry (if provided), for geographical reconnaissance (if provided), for entomological surveillance (if provided), and for informational/educational information to be provided (if any) to residents in the target area.

The cost estimate for personal protection equipment is calculated using a personal protection worksheet 370 seen in FIG. 16, which estimates a cost for protection per spray operator using reference data stored in the storage media. This worksheet and other worksheets can be accessed by a user by clicking on a text field for the specific subject on questionnaire 40. For example, if personal protection equipment will be part of the estimate, clicking on the text field on line 29 of the questionnaire 40 takes the user to worksheet 374 seen in FIG. 16. The total figure for personal protection equipment is then inserted in field 129 of the questionnaire 40. The figure for personal protection equipment is multiplied by the number of spray operators to provide the cost estimate for personal protection equipment.

The program includes a cost estimate for laundry in the needs-assessment report 42 if the user checks “yes” in the field 149 for line 49 of the questionnaire 40. When laundry is to be provided, the program calculates the laundry cost using the laundry worksheet 372 seen in FIG. 16.

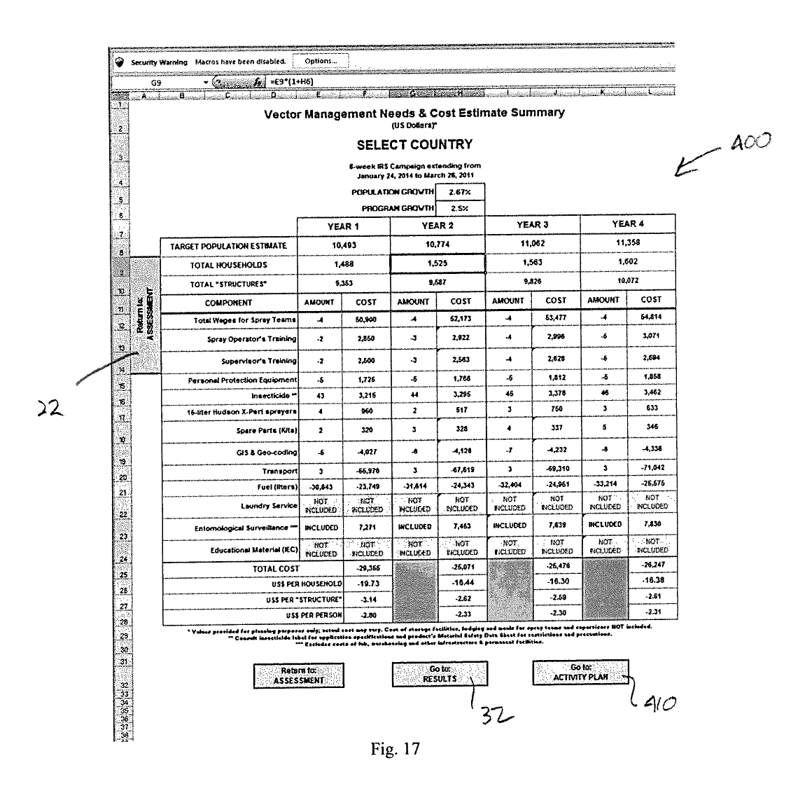

Similarly, the program includes cost estimates for geographical reconnaissance and for entomological surveillance in the needs-assessment report 42 if the user checks “yes” in the fields 145, 148 for lines 45 and 48 of the questionnaire 40. Clicking on the corresponding text field takes the user to the respective worksheet. When geographical reconnaissance and/or entomological surveillance is to be provided, the program calculates the cost using the geographical reconnaissance worksheet 374 seen in FIG. 16 and/or the entomological surveillance worksheet 376 seen in FIG. 17.

When a user clicks “yes” in the field 151 for line 51 of the questionnaire 40 concerning distribution of informational or educational material to be distributed to residents, the program asks the user for a cost estimate per household and includes an IEC cost estimate for that material in the wages and equipment subsection 344 of the cost estimate section 304 of the needs-assessment report 42. In this example, the IEC cost estimate is calculated by first retrieving the value entered by the user in the field 152 for line 52 of the questionnaire for the cost of IEC material per household, and multiplying that by the number of households calculated using the demographic information in the box 240 of the population worksheet 220.

The training requirements subsection 346 (FIG. 15) of the needs-assessment report 42 includes a training estimate that is calculated by the program when the user clicks “yes” in the field 147 for line 47 of the questionnaire 40. When operator training is to be provided, the program calculates the cumulative number of spray operators identified in the pertinent boxes 246 from the population worksheet 220, divides it by 25-30 to determine how many operator training sessions will be needed and multiplies that number by a session cost (for example, about $1850 per session) to arrive at an operator training cost that is reported in narrative form. When the user clicks “yes” in the field 146 for line 46 to indicate that supervisor training is to be provided, the program calculates the cumulative number of supervisors identified in the boxes 248 and divides it by 20 to determine how many supervisor training sessions will be needed and multiplies that number by a session cost (for example, around $2500 per session) to arrive at a supervisor training cost that is also reported in narrative form. The program sums the two training costs and reports the sum as a total training cost.

In this example, a template for the training requirements subsection 346 can read:
A ______-day training session for groups of 25-30 spray operators is planned to begin soon after completing the supervisor's training and end a week or so prior to the start of the spray campaign. Each session is estimated to cost about US$ ______. Thus, the total cost of the ______ training sessions needed to train all ______ technicians has been estimates at US$ ______.
A ten-day cascade training session for groups of 20 or so spray team supervisors is planned for completion a week or so prior to the beginning of the spray operator's training at a cost of US$ ______ per session.
The combined cost of training IRS team members and their supervisors has been estimated at approximately US$ ______.

### THE MULTI-YEAR BUDGET

When a user clicks on the budget link 46, the program generates or retrieves a multi-year budget 400 seen in FIG. 17. The budget displays the population growth estimate and the program growth estimates provided by the user in the fields 106, 112 for lines 6 and 12 of the questionnaire 40, which the program retrieves from the storage media. The program estimates the population in future years based on the current year population and the population growth estimates. The program also uses the program estimate to calculate total wages for spray teams, training costs for both operators and supervisors, costs for personal protection equipment, insecticide costs, other equipment costs, GIS and geo-coding costs, transportation costs, fuel costs, laundry costs (if any), entomological survey costs (if any) and educational material costs (if any) for future years. These estimates are displayed on the budget, along with an annual total cost, an annual per-household cost, an annual per-structure cost, and an annual per-person cost. Line items to which the answer was “no” in the questionnaire 40 are not included and are displayed as “Not included” in the multi-year budget 400 that is presented on-screen.

When the program displays the multi-year budget 400 on-screen, it also displays a questionnaire link 22, a results link 32, and a schedule link 410. These links are not included in the report when it is printed.

### THE OPERATIONAL CALENDAR

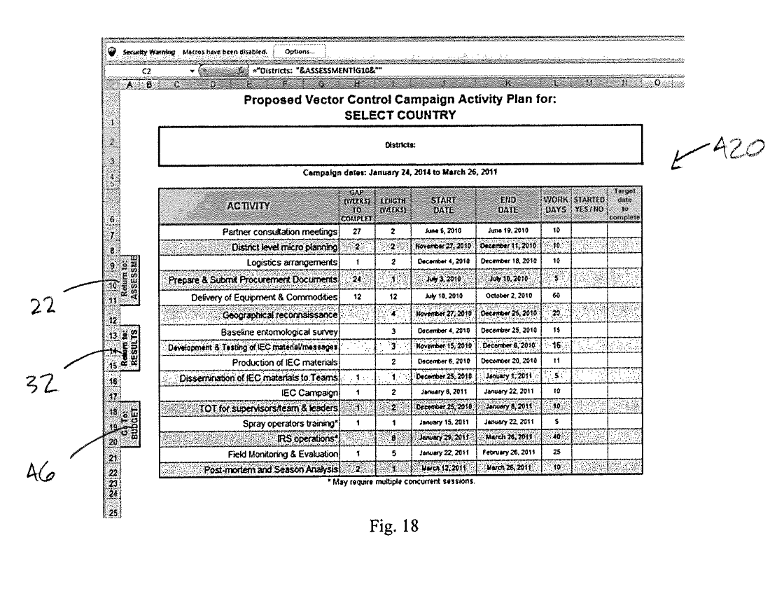

When a user clicks on the schedule link 410, the program generates an operational calendar 420 like the one seen in FIG. 18. The operational calendar displays the different tasks that need to be performed in preparation for the program, and provides estimates of when each of those tasks should begin and be completed.

The illustrated operational calendar 420 lists planning meetings; logistical arrangements; document preparation; delivery of equipment; geographical reconnaissance; baseline entomological surveillance; development, production, and delivery of IEC materials; training; spraying and post-spraying activities as separate tasks. The duration of these tasks is calculated by the program after retrieving the “expected day of completion” from field 114 of the questionnaire 40 and adjusting the starting and ending dates based on the “Length (WEEKS)” field of the calendar 420 and other schedule data stored in the storage media.

When the program displays the operational calendar 420 on-screen, it also displays a questionnaire link 22, a results link 32, and a budget link 46. These links are not included in the report when it is printed.

This description of various embodiments of the invention has been provided for illustrative purposes. Revisions or modifications may be apparent to those of ordinary skill in the art without departing from the invention. The full scope of the invention is set forth in the following claims.

1. A computerized estimating tool that is used to create needs assessment estimates for a proposed insect-control spray campaign utilizing indoor residual spraying (IRS) and has:
a means for inputting data;
a display;
a non-transitory computer-readable storage media; and
machine readable instructions stored in the non-transitory media that, when executed by a processor, cause the tool:
(a) to present on the display an electronic questionnaire that asks a user to input:
(i) demographic information about the population of the geographic area where the proposed insect-control spray campaign is being considered for use; and
(ii) workforce data concerning a proposed insect-control spray campaign,
(b) to retrieve the input data and use it to calculate both a budget and an operational calendar for the proposed insect-control spray campaign, and
(c) to retrieve the input data and use it to calculate results and represent those calculated results in generate a printable, narrative-form needs-assessment report.

2. A computerized estimating tool as recited in claim 1, in which:
the electronic questionnaire has a field that, when clicked by the user, opens a worksheet that has boxes in which a user is asked to provide information;
the means for inputting data enables a user to input data into the boxes; and
the machine-readable instructions, when executed by the processor, cause the tool to use data input by the user into the boxes to calculate further data that is then displayed both in another field on the electronic questionnaire and in the needs-assessment report.

3. A computerized estimating tool as recited in claim 1, in which:
the questionnaire also asks users to provide IRS-specific information pertaining to insecticide selection and related materials, and the program retrieves that data and uses it to generate the needs-assessment report.

4. A computerized estimating tool as recited in claim 1, in which:
the electronic questionnaire has a field that, when clicked by the user, opens a population worksheet that has demographic boxes in which a user is asked to provide demographic information on individual villages or communities to be included in a proposed insect-control spray campaign, separate demographic boxes being provided for the name of each of those villages or communities, their populations, the number of households in each of those villages or communities, and the relative proportions of households in each of those villages or communities that are categorized as rural vs. urban;
the means for inputting data enables a user to input data into the boxes; and
the machine-readable instructions, when executed by the processor, cause the tool to retrieve input names of each of the villages or communities and display them in the needs-assessment report.

5. A computerized estimating tool as recited in claim 1, in which:
the electronic questionnaire asks the user to input a desired end date for the proposed insect-control spray campaign; and
the machine-readable instructions, when executed by the processor, cause the tool to retrieve the desired end date, the demographic information, and the workforce data, to use that data to calculate a start date for the proposed insect-control spray campaign, and to display that start date in the operational calendar.

6. A computerized estimating tool as recited in claim 1, in which the machine-readable instructions, when executed by the processor, cause the tool to use the demographic information, the estimated worker spray rates, and other workforce data to calculate a budget for the proposed insect-control spray campaign.

7. A computerized estimating tool that is used to create needs assessment estimates for a proposed insect-control spray campaign utilizing indoor residual spraying (IRS) and has:
a means for inputting data;
a display;
a non-transitory computer-readable storage media; and
machine-readable instructions stored on the non-transitory storage media that, when executed by a processor, cause the tool:
(a) to present on the display an electronic questionnaire that asks a user to input:
(i) demographic information about the population of the geographic area where the proposed insect-control spray campaign is being considered for use; and
(ii) workforce data concerning a proposed insect-control spray campaign, and
(b) to retrieve and display, when a user clicks on a workforce data field, instructions relating to the completion of that field; and
(c) to retrieve input data and use it to calculate results and present those calculated results in a generate a printable, narrative-form needs-assessment report.

8. A computerized estimating tool that is used to create and evaluate a proposed insect-control spray campaign and has:
a means for inputting data;
a display;
non-transitory computer-readable storage media; and
machine-readable instructions stored on the non-transitory computer readable storage media that, when executed by a processor, cause the tool:
(a) to present on the display an electronic questionnaire that:
(i) has a field that, when clicked by a user, opens a population worksheet that has demographic boxes in which a user is asked to provide demographic information on individual villages or communities to be included in a proposed insect-control spray campaign, separate demographic boxes being provided for the name of each of those villages or communities, their populations, the number of households in each of those villages or communities, and the relative proportion of households in each of those villages or communities that are categorized as rural or urban,
(ii) asks the user to input a desired end date for the proposed insect-control spray campaign,
(iii) provides a pull-down menu of possible insecticides for use in the proposed insect-control spray campaign,
(iv) asks the user to input an estimated worker spray rate for rural households and an estimated spray rate for urban households, and
(v) asks the user to input other workforce data concerning the proposed insect-control spray campaign,
(b) to retrieve the demographic information, the estimated worker spray rates, and the other workforce data and use it to calculate a budget for the proposed insect-control spray campaign,
(c) to retrieve stored scheduling data, the demographic information, the desired end date, the estimated worker spray rates, and the other workforce data and use it to calculate the length of the spray campaign and to generate an operational calendar for the proposed insect-control spray campaign, and
(d) to present the calculated results in generate a printable, text-form needs-assessment report based on the input data.
